(19) United States
(12) Patent Application Publication
(10) Pub. No.: US 2016/0114483 A1
(43) Pub. Date: Apr. 28, 2016

(54) ROBOT CONTROL METHOD, ROBOT APPARATUS, PROGRAM, RECORDING MEDIUM, AND MANUFACTURING METHOD OF ASSEMBLY PART

(71) Applicant: CANON KABUSHIKI KAISHA, Tokyo (JP)

(72) Inventors: Takahiro Ishikawa, Kawasaki-shi (JP); Tsutomu Osaka, Yokohama-shi (JP); Shunsuke Kawamura, Toride-shi (JP)

(21) Appl. No.: 14/920,719

(22) Filed: Oct. 22, 2015

(30) Foreign Application Priority Data
Oct. 24, 2014 (JP) 2014-217032

(51) Int. Cl. B25J 9/16; B25J 9/06; B25J 9/12

(52) U.S. Cl. CPC B25J 9/1641; B25J 9/12; B25J 9/06; Y10S 901/09

(57) ABSTRACT

Rotations of respective motors are controlled so that rotational angles of the respective motors become target angles in an operation completion position of a first operation (S1: robot operation step). After the robot operation step, a leading edge position of a robot is obtained based on joint angles detected by respective output side encoders (S5: leading edge position calculation step). A convergence time until an amplitude at the leading edge of the robot with respect to the operation completion position converges within an allowable range is estimated based on a time change of the calculated leading edge position (S6: estimation step). Rotational operations of the respective motors are paused from a time point at which the rotational angles of the respective motors are controlled to be the target angles to a time point at which an elapsed time reaches the estimated convergence time (S3 and S7: pause step).

### BACKGROUND OF THE INVENTION

1. Field of the Invention

The present invention relates to a robot control method for controlling a multijoint robot, a robot apparatus, a program, a recording medium, and a manufacturing method of an assembly part.

2. Description of the Related Art

Various robot apparatuses have been conventionally used in factories and the like. In recent years, a robot apparatus including a multijoint robot for enabling more complicated operations has widely spread.

When a multijoint robot is used as a production apparatus, it is necessary to operate the robot at the highest possible speed for enhancing the work efficiency. To this end, it is necessary to promptly detect that the robot surely reaches a commanded position during an operation. In short, positioning completion needs to be quickly detected.

The positioning completion detection of the robot is determined as follows. A position on a motor shaft, i.e., a position on a speed reducer input side is detected by an encoder coupled to a motor of each joint, and the positioning completion detection is determined upon a difference between the detected position and a commanded position value falling below a predetermined determination value.

At this time, vibration attributed to low rigidity of the robot is generated at the leading edge of the robot. Thus, the following technique has been conventionally proposed for the positioning completion detection of the robot. For example, there has been proposed a method of estimating a leading edge position of a robot from a position, a speed, and a torque command value of a motor, and determining positioning completion if the estimated value is within a preset allowable value of the leading edge position (refer to Japanese Patent Application Laid-Open No. 3-257506).

Nevertheless, the technique described in Japanese Patent Application Laid-Open No. 3-257506 estimates the leading edge position of the robot through calculation, based on an angle detected by an encoder for detecting a rotational angle of a rotational shaft of the motor. In other words, an angle on a speed reducer input side is detected. A speed reducer having low rigidity and being liable to generate vibration is interposed between the speed reducer input side and the leading edge of the robot. It is therefore difficult to accurately obtain an error caused by deflection and hysteresis of the speed reducer, based on the value on the speed reducer input side. Thus, vibration at the leading edge of the robot may not actually converge. This lowers the accuracy of an assembly work, and causes a reliability problem.

In addition, it is conceivable to stop an operation of a robot for a preset time before shifting to the next operation. If this stop time is set with a considerable margin, the vibration of the robot can be converged within a predetermined allowable range. This, however, results in accumulation of extra time (margin) if the same assembly operation is repeatedly performed, and the work efficiency of the robot accordingly degrades. In contrast, if the stop time is set to be short, the next operation may be started without the vibration at the leading edge of the robot being converged. In this case, the accuracy of the next operation decreases. This may cause an error such as assembly failure and robot collision.

### SUMMARY OF THE INVENTION

The present invention aims to enhance the work efficiency of a robot while ensuring the operating accuracy of a multijoint robot.

According to an aspect of the present invention, a robot control method for a multijoint robot including motors for driving respective joints, and joint angle detectors for detecting angles of the respective joints, and for causing the robot to perform a second operation after causing the robot to perform a first operation, by controlling rotations of the respective motors by a control means, includes a robot operation step of controlling, by the control means, rotations of the respective motors so that rotational angles of the respective motors become target angles in an operation completion position of the first operation, a leading edge position calculation step of obtaining, by the control means, a position of a leading edge of the robot based on joint angles detected by the respective joint angle detectors, after the robot operation step, an estimation step of estimating, by the control means, a convergence time from when the rotational angles of the respective motors are controlled to be the target angles in the robot operation step to when an amplitude at the leading edge of the robot with respect to the operation completion position converges within an allowable range, based on a time change of the position of the leading edge of the robot that is calculated in the leading edge position calculation step, and a pause step of pausing, by the control means, rotational operations of the respective motors at least from a time point at which the rotational angles of the respective motors are controlled to be the target angles in the robot operation step to a time point at which an elapsed time reaches the convergence time estimated in the estimation step, before causing the robot to perform the second operation.

Further features of the present invention will become apparent from the following description of exemplary embodiments (with reference to the attached drawings).

### BRIEF DESCRIPTION OF THE DRAWINGS

FIG. 1 is a perspective view illustrating a robot apparatus according to a first exemplary embodiment.

FIG. 2 is a partial cross-sectional view illustrating a second joint of a robot arm illustrated in FIG. 1.

FIG. 3 is a block diagram illustrating a configuration of a control device of the robot apparatus according to the first exemplary embodiment.

FIG. 4 is a functional block diagram illustrating a control system of the robot apparatus according to the first exemplary embodiment.

FIG. 5 is a flowchart illustrating each step of a robot control method in the robot apparatus according to the first exemplary embodiment.

FIG. 6 illustrates graphs for describing vibration statuses of a leading edge of a robot in respective axis directions in a world coordinate system according to the first exemplary embodiment.

FIG. 7 is a flowchart illustrating an estimation step in the robot control method according to the first exemplary embodiment.

FIG. 8 is a conceptual diagram for describing the estimation step in the robot control method according to the first exemplary embodiment.

FIG. 9 is a functional block diagram illustrating a control system of a robot apparatus according to a second exemplary embodiment.

FIG. 10 is a diagram for describing data processing of a chronological change in a determination processing unit of the robot apparatus according to the second exemplary embodiment.

FIG. 11 is a flowchart illustrating each step of a robot control method in the robot apparatus according to the second exemplary embodiment.

### DESCRIPTION OF THE EMBODIMENTS

Exemplary embodiments of the present invention will be described in detail below with reference to the drawings.

### First Exemplary Embodiment

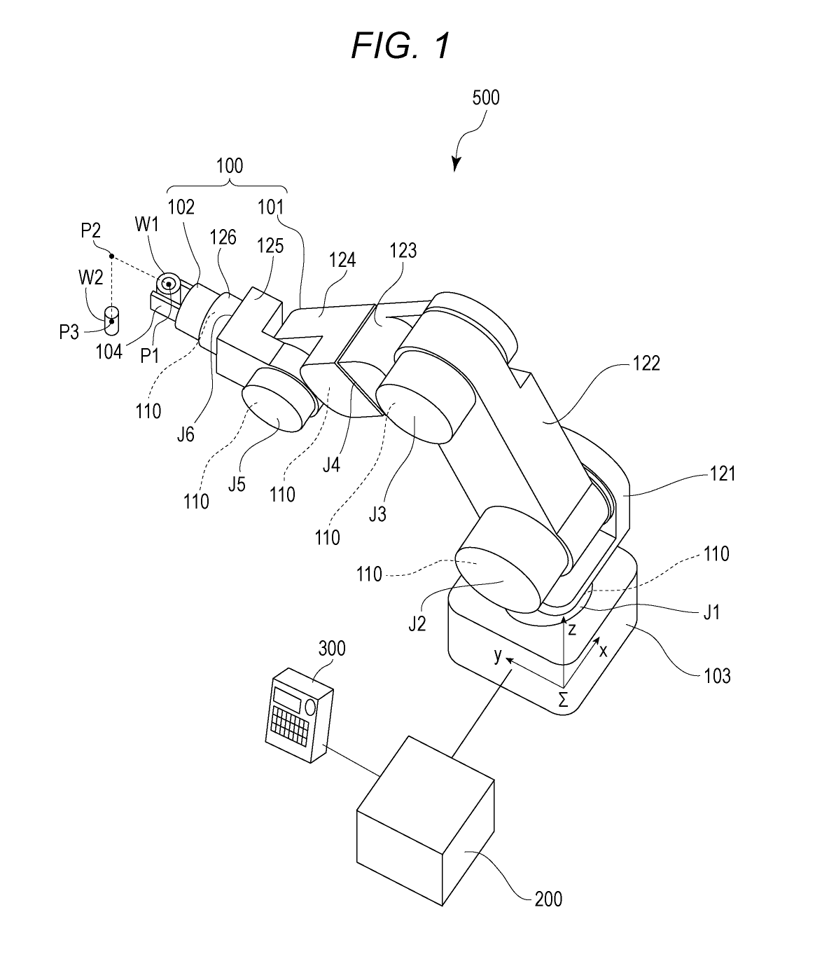

FIG. 1 is a perspective view illustrating a robot apparatus according to a first exemplary embodiment of the present invention. A robot apparatus 500 illustrated in FIG. 1 is an industrial robot. The robot apparatus 500 includes a robot 100, a control device 200, and a teaching pendant 300. The robot 100 manufactures an assembly part by assembling a gripped first part W1 to a second part W2. The control device 200 serves as a control means for controlling the robot 100. The teaching pendant 300 is connected to the control device 200.

The robot 100 is a multijoint robot. The robot 100 includes a robot arm 101 of a vertical multijoint type and a robot hand 102 being an end effector connected to the leading edge of the robot arm 101.

A tool-center point (TCP) is set at the leading edge of the robot 100 (the leading edge of the robot hand 102 or the robot arm 101). When a teaching point of the robot 100 is designated in a task space, the teaching point is represented by a parameter indicating the position and orientation of the TCP in a world coordinate system Σ of the robot 100. When the teaching point is designated in a configuration space (joint space), the teaching point is represented by a parameter indicating a joint angle of each joint of the robot 100. In addition, a teaching point designated in a configuration space can be converted into a task space by direct kinematics calculation, whereas a teaching point designated in a task space can be converted into a configuration space by inverse kinematic calculation. Here, the world coordinate system Σ is represented by mutually-perpendicular three axes consisting of two axes (an x-axis and a y-axis) perpendicular to each other in a horizontal direction, and one axis (z-axis) perpendicular to the two axes, with an original point being set to the base end of the robot 100.

The robot arm 101 includes a base portion (base end link) 103 fixed to a workbench, and a plurality of links 121 to 126 for transmitting displacement and force. The base portion 103 and the plurality of links 121 to 126 are pivotably or rotatably coupled to one another by a plurality of joints J1 to J6. In addition, the robot arm 101 includes joint drive devices 110 provided on the respective joints J1 to J6 so as to drive the respective joints J1 to J6. As the joint drive devices 110 provided on the respective joints J1 to J6, the ones having respective appropriate outputs are used according to the magnitude of required torques.

The robot hand 102 includes a plurality of gripping claws (fingers) 104, a driving unit (not illustrated), an encoder (not illustrated), and a mechanism (not illustrated). The plurality of gripping claws 104 grips the part W1. The driving unit (not illustrated) drives the plurality of gripping claws 104. The encoder (not illustrated) detects a rotational angle of the driving unit. The mechanism (not illustrated) converts rotation into a gripping operation, and is designed in accordance with gripping operations necessary for a cam mechanism, a link mechanism, and the like. In addition, although a torque required for the driving unit used in the robot hand 102 is different from that for joints of the robot arm 101, the basic configuration is the same. The robot hand 102 further includes a force sensor (not illustrated) that can detect force (reactive force) or moment that is exerted on the gripping claws 104 or the like.

The teaching pendant 300 is configured to be connectable to the control device 200, and is configured to be able to transmit, to the control device 200, a command for performing drive control of the robot arm 101 and the robot hand 102, when being connected to the control device 200.

Hereinafter, the joint drive device 110 in the joint J2 will be described as an example, on behalf of those in the other joints. The joint drive devices 110 of the other joints J1, and J3 to J6 have similar configurations though sizes and performances thereof may be different. Thus, the descriptions thereof will be omitted.

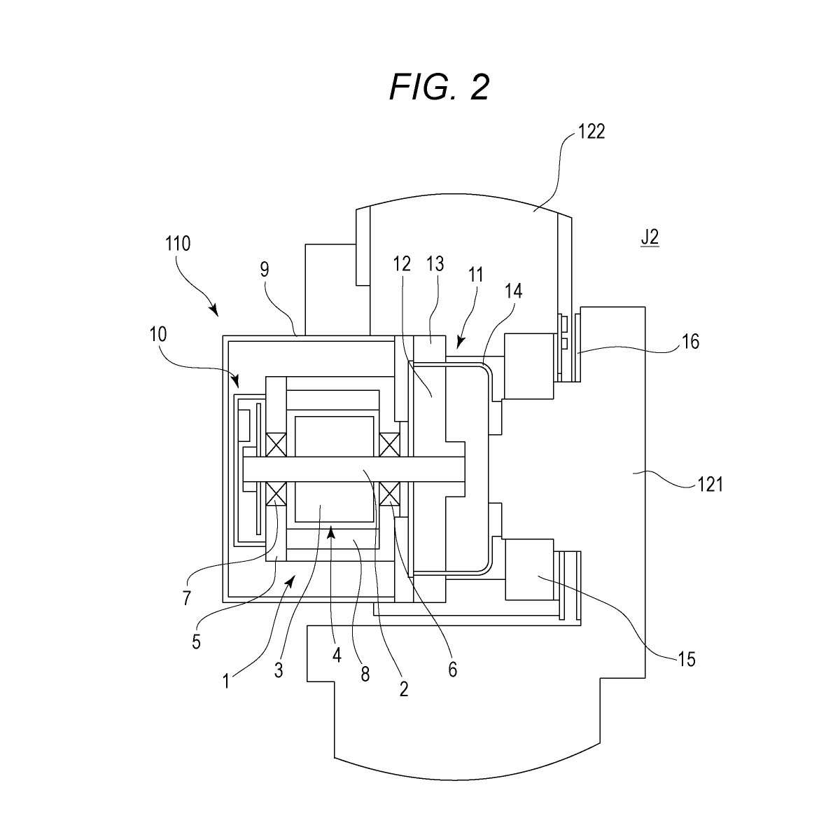

FIG. 2 is a partial cross-sectional view illustrating the joint J2 of the robot arm 101. The joint drive device 110 includes a servomotor (hereinafter, referred to as a “motor”) 1 and a speed reducer 11. The motor 1 is an electrical motor serving as a driving source for driving the joint J2. The speed reducer 11 reduces the speed of rotation of a rotational shaft 2 of the motor 1 to output the resultant torque.

The joint drive device 110 further includes an input side encoder 10, which is a motor angle detector for detecting a rotational angle (an output angle) of the rotational shaft 2 of the motor 1. The joint drive device 110 further includes an output side encoder 16, which is a joint angle detector for detecting a joint angle of the joint J2, i.e., a rotational angle (an output angle) of an output shaft of the speed reducer 11.

The motor 1 is, for example, a brushless direct current (DC) servomotor or alternating current (AC) servomotor. The motor 1 includes a rotation unit 4, a motor housing 5, bearings 6 and 7, and a stator coil 8. The rotation unit 4 includes the rotational shaft 2 and a rotor magnet 3. The bearings 6 and 7 rotatably support the rotational shaft 2. The stator coil 8 rotates the rotation unit 4. The bearings 6 and 7 are provided on the motor housing 5. The stator coil 8 is attached to the motor housing 5. In addition, the motor 1 is surrounded by a motor cover 9.

The input side encoder 10 is an optical or magnetic rotary encoder, and is provided at one end of the rotational shaft 2 of the motor 1. The input side encoder 10 generates a pulse signal in accordance with the rotation of the rotational shaft 2 of the motor 1, and outputs the generated pulse signal to the control device 200. In addition, although the input side encoder 10 is attached to the rotational shaft 2, the input side encoder 10 may be attached to an input shaft of the speed reducer 11.

The output side encoder 16 is an optical or magnetic rotary encoder, and detects an output angle of the speed reducer 11. In the first exemplary embodiment, the output side encoder 16 detects a relative angle between the base portion 103 and the link 121 or between two adjacent links. In the joint J2, the output side encoder 16 detects a relative angle between the links 121 and 122. Specifically, the output side encoder 16 generates a pulse signal in accordance with the driving of the joint J2 (a relative movement between the links 121 and 122), and outputs the generated pulse signal to the control device 200.

The links 121 and 122 are rotatably coupled to each other via a cross roller bearing 15. A brake unit for holding the orientation of the robot arm 101 during a power-off state may be provided as necessary between the motor 1 and the input side encoder 10.

In the first exemplary embodiment, the speed reducer 11 is a compact and lightweight strain wave gearing speed reducer having a large speed reduction ratio. The speed reducer 11 includes a wave generator 12 and a circular spline 13. The wave generator 12 is coupled to the rotational shaft 2 of the motor 1, and has an input shaft. The circular spline 13 is fixed to the link 122, and has an output shaft. In addition, although the circular spline 13 is directly coupled to the link 122, the circular spline 13 and the link 122 may be integrally formed.

The speed reducer 11 further includes a flexspline 14 arranged between the wave generator 12 and the circular spline 13, and fixed to the link 121. The speed of the flexspline 14 is reduced at a speed reduction ratio N with respect to the rotation of the wave generator 12, and the flexspline 14 relatively rotates with respect to the circular spline 13. Accordingly, the rotating speed of the rotational shaft 2 of the motor 1 is reduced by the speed reducer 11 to 1/N, and the link 122, to which the circular spline 13 is fixed, is relatively rotated with respect to the link 121, to which the flexspline 14 is fixed, thereby inflecting (rotating) the joint J2. A rotational angle on the output side of the speed reducer 11 obtainable at this time corresponds to an actual output angle, i.e., an angle (a joint angle) of the joint J2.

The vibration of the robot 100 is attributed to low rigidity of the robot 100. In the present exemplary embodiment, a dominating factor of the vibration is the speed reducer 11. Thus, if the vibration status of the speed reducer 11 is identified, the accuracy of convergence detection can be improved.

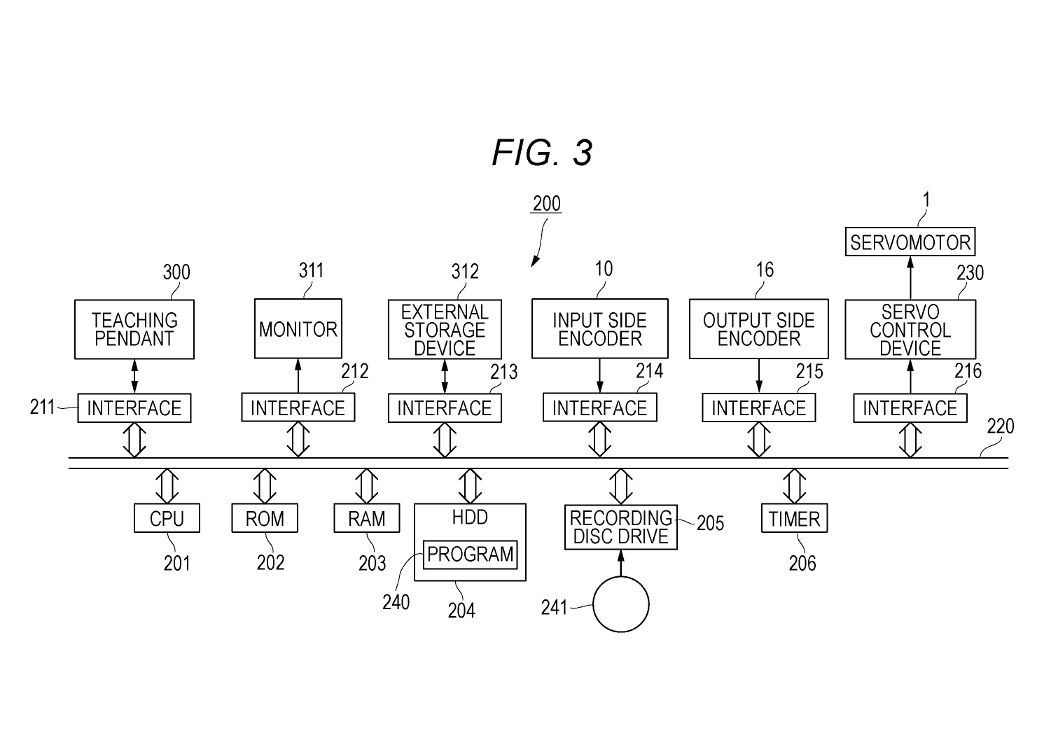

FIG. 3 is a block diagram illustrating a configuration of the control device 200 of the robot apparatus 500. The control device 200 serving as a control means includes a central processing unit (CPU) 201 as a control unit (a calculation unit). The control device 200 further includes, as a storage means, a read only memory (ROM) 202, a random access memory (RAM) 203, and a hard disk drive (HDD) 204. The control device 200 further includes a recording disc drive 205, a timer 206 serving as a time measuring means, and various interfaces 211 to 216. The control device 200 further includes a servo control device 230 connected to the interface 216.

The ROM 202, the RAM 203, the HDD 204, the recording disc drive 205, the timer 206, and the various interfaces 211 to 216 are connected to the CPU 201 via a bus 220. The ROM 202 stores a basic program such as a Basic Input/Output System (BIOS). The RAM 203 is a storage device for temporarily storing various types of data such as an arithmetic operation processing result of the CPU 201.

The HDD 204 is a storage device for storing an arithmetic operation processing result of the CPU 201, various types of data acquired from the outside, and the like. The HDD 204 also has a function of recording a program 240 for causing the CPU 201 to execute various types of arithmetic operation processing to be described below. The CPU 201 executes each step of a robot control method based on the program 240 recorded (stored) in the HDD 204.

The recording disc drive 205 can read various types of data, a program, and the like that are recorded on a recording disc 241. The timer 206 counts a time, and outputs data of the counted time to the CPU 201. Alternatively, the CPU 201 may have the function of the timer 206.

The teaching pendant 300 operable by a user is connected to the interface 211. The teaching pendant 300 outputs data of input teaching points (target angles of the respective joints J1 to J6 in the case of the teaching points being designated in a configuration space) to the CPU 201 via the interface 211 and the bus 220. The CPU 201 sets the data of the teaching points input from the teaching pendant 300, into a storage unit such as the HDD 204.

A monitor 311 and an external storage device 312 are connected to the interfaces 212 and 213, respectively. Various images are displayed on the monitor 311. Examples of the external storage device 312 include a rewritable nonvolatile memory and an external HDD.

The input side encoder 10 and the output side encoder 16 are connected to the interfaces 214 and 215, respectively. The input side encoder 10 and the output side encoder 16 output the above-described pulse signals to the CPU 201 via the interfaces 214 and 215, and the bus 220.

The servo control device 230 is connected to the interface 216. The CPU 201 generates a trajectory linking teaching points, and outputs data of a drive command indicating a control amount of a rotational angle of the rotational shaft 2 of the motor 1, to the servo control device 230 via the bus 220 and interface 216 at a predetermined time interval.

The servo control device 230 calculates an output amount of current supplied to the motor 1 by feedback control, based on the drive command input from the CPU 201. The servo control device 230 then supplies current to the motor 1 to perform joint angle control of the joints J1 to J6 of the robot arm 101. In other words, the CPU 201 controls, via the servo control device 230, driving of the joints J1 to J6 by the motor 1 so that angles of the joints J1 to J6 become target angles.

In addition, in the present exemplary embodiment, the description is given of a case in which the HDD 204 is a computer-readable recording medium, and the program 240 is stored in the HDD 204. This, however, is not a limiting case. The program 240 may be recorded on any recording medium so long as the recording medium is a computer-readable recording medium. For example, as a recording medium for supplying the program 240, the ROM 202, the external storage device 312, the recording disc 241 that are illustrated in FIG. 3, and the like may be used. The description will be given with specific examples. A flexible disk, a hard disc, an optical disc, a magneto-photo disk, a compact disc read only memory (CD-ROM), a CD recordable (CD-R), a magnetic tape, a nonvolatile memory, a ROM, and the like can be used as a recording medium.

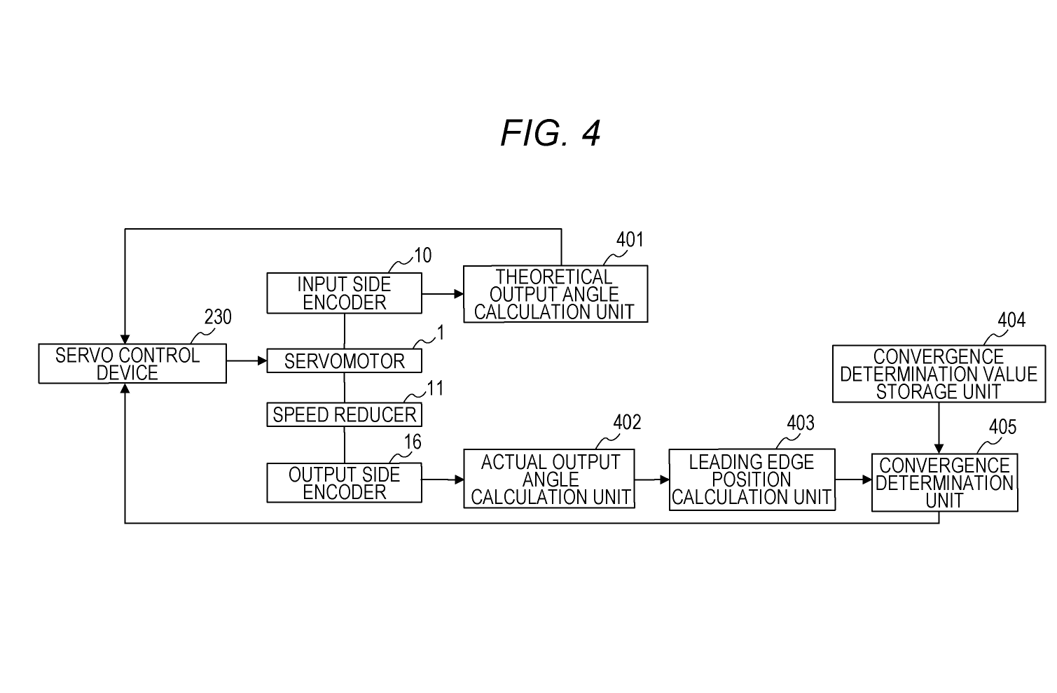

Functions of the CPU 201 and the HDD 204 that are used when a below-described convergence detection program is executed will now be described with reference to FIG. 4. FIG. 4 is a functional block diagram illustrating a control system of the robot apparatus 500 according to the first exemplary embodiment. Here, the CPU 201 illustrated in FIG. 3 and serving as a control unit (calculation unit) executes the program 240, whereby the CPU 201 functions as each of calculation units 401, 402, 403, and 405 illustrated in FIG. 4. In addition, the HDD 204 serving as a storage means functions as a storage unit 404. Each unit will be described below.

The theoretical output angle calculation unit 401 counts pulse signals of the respective input side encoders 10 to obtain rotational angles θₘ₁ to θₘ₆ of the motors 1. In other words, the theoretical output angle calculation unit 401 acquires data of the rotational angles θₘ₁ to θₘ₆ of the motors 1 that are detected by the respective input side encoders 10. In addition, the theoretical output angle calculation unit 401 calculates, from a speed reduction ratio N, output angles of the speed reducer 11, i.e., theoretical output angles θ₁ to θ₆ converted into joint angles of the joints J1 to J6. Specifically, the theoretical output angle calculation unit 401 calculates e (θ₁ to θ₆)=θₘ (θₘ₁ to θₘ₆)/N. These values θ₁ to θ₆ are fed back via the servo control device 230, so that angles of the joints J1 to J6 are controlled to be target joint angles of the respective joints J1 to J6 that are input from the teaching pendant 300.

The actual output angle calculation unit 402 receives input of pulse signals from the respective output side encoders 16 to obtain actual joint angles θ_{J1} to θ_{J6} of the respective joints J1 to J6. In other words, the actual output angle calculation unit 402 acquires data of the actual joint angles θ_{J1} to θ_{J6} of the respective joints J1 to J6 from the respective output side encoders 16.

The above-described theoretical output angles θ₁ to θ₆ are theoretical values of rotational angles of the joints J1 to J6 (output shaft of the speed reducer 11) that are estimated based on the rotational angles θₘ₁ to θₘ₆ of the motors 1 (input shaft of the speed reducer 11). On the other hand, the joint angles θ_{J1} to θ_{J6} are actual measurement values calculated (i.e., detected by the respective output side encoders 16) based on pulse signals generated by the respective output side encoders 16, and values containing vibration caused by deflection of the speed reducer 11.

The leading edge position calculation unit 403 calculates, according to direct kinematics, a position of a leading edge (TCP) of the robot 100 based on the joint angles θ_{J1} to θ_{J6} calculated by the actual output angle calculation unit 402.

The convergence determination value storage unit 404 stores a width of a misalignment amount allowable as a positioning completion position (i.e., an allowable range and a convergence width in which vibration can be determined to have converged), at the leading edge position of the robot 100.

The convergence determination unit 405 determines convergence (positioning completion) of the leading edge of the robot 100 based on values obtained from the leading edge position calculation unit 403 and the convergence determination value storage unit 404. The convergence determination unit 405 then issues, to the servo control device 230, a command for shifting to the next operation.

The description will now be given of a case of manufacturing an assembly part by assembling the part W1 to the part W2 by operating the leading edge (TCP) of the robot 100 in the order of teaching points P1, P2, and P3, as illustrated in FIG. 1. In FIG. 1, an operation of moving from the teaching point P1 toward the teaching point P2 is regarded as a first operation, and an operation of moving from the teaching point P2 toward the teaching point P3 is regarded as a second operation. When shifting the robot 100 from the first operation to the subsequent second operation, the control device 200 temporarily stops the robot 100 at a position of the teaching point P2 for the purpose of converging the vibration of the robot 100.

In other words, in the first operation, the control device 200 performs feedback control so that detected angles detected by the respective input side encoders 10 become the teaching point P2 designated in the configuration space (i.e., target angles of the respective joints J1 to J6). Since the control device 200 performs feedback control based on the detection results of the input side encoders 10, the leading edge of the robot 100 can reach the teaching point P2 faster than a case in which the control device 200 performs feedback control based on the detection results of the output side encoders 16. The robot 100, however, is affected by inertia force caused by the first operation, and the robot 100 vibrates due to deflection of the speed reducer 11 or the like when the leading edge of the robot 100 reaches the teaching point P2. It is difficult to accurately obtain such vibration caused by the speed reducer 11, based on angles of the motors 1 (detected angles detected by the input side encoders 10). If the second operation, i.e., an operation of manufacturing an assembly part by assembling the part W1 to the part W2 is performed in a state in which the vibration of the robot 100 does not converge, the assembling may fail.

Thus, it is conceivable to actually measure the vibration of a robot, and to determine, based on an allowable value, whether the vibration converges within a predetermined convergence width (the allowable value). Nevertheless, when allowable value determination is performed, even though the vibration of the robot becomes equal to or shorter than an allowable value only for a moment, the vibration may exceed the allowable value at the peak of next vibration. Thus, it is necessary to stand by at least for a time corresponding to one cycle or more of the vibration.

Thus, in the first exemplary embodiment, the robot 100 is configured to estimate a convergence time of the vibration of the leading edge of the robot 100, and to execute the subsequent second operation after being paused for the estimated convergence time from a time point at which the leading edge of the robot 100 reaches the teaching point P2 by the robot 100 being caused to perform the first operation. This convergence time is estimated by the above-described convergence determination unit 405.

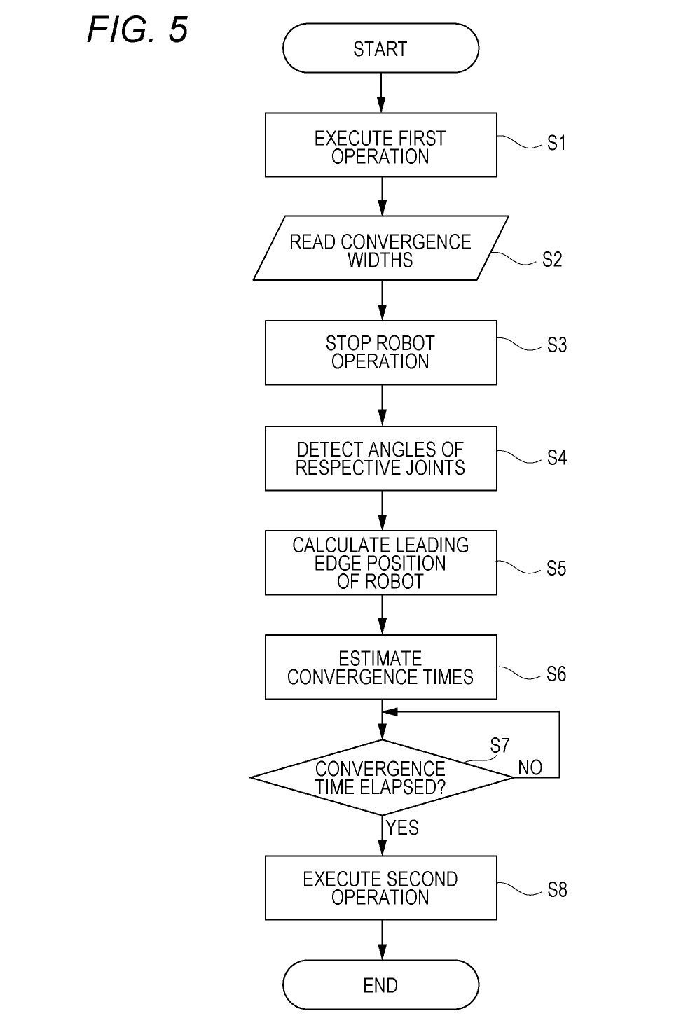

FIG. 5 is a flowchart illustrating each step of a robot control method (convergence time detection method) in the robot apparatus according to the first exemplary embodiment of the present invention. First, based on a command from the CPU 201, the servo control device 230 causes the robot 100 to execute the first operation (a detection target operation) (step S1: robot operation step). The servo control device 230 performs feedback control of position information from the input side encoder 10 based on a command from the CPU 201. In other words, the servo control device 230 controls, under control of the CPU 201, rotations of the respective motors 1 so that the rotational angles θₘ₁ to θₘ₆ detected by the respective input side encoders 10 become target angles θₘ₁* to θₘ₆* for the leading edge of the robot 100 moving to an operation completion position of the first operation. Through such control, the leading edge (TCP) of the robot 100 (the robot arm 101) can be brought closer to the teaching point P2.

In addition, controlling the rotational angles θₘ₁ to θₘ₆ to be the target angles θₘ₁* to θₘ₆* has the same meaning as controlling angles θ₁ to θ₆ obtained by dividing the rotational angles θₘ₁ to θₘ₆ by the speed reduction ratio N to be the target angles θ₁* to θ₆* obtained by dividing the target angles θₘ₁* to θₘ₆* by the speed reduction ratio N. The target angles θ₁* to θ₆* are target joint angles. In addition, the “operation completion position” of the first operation position corresponds to positional coordinates x₀, y₀, and z₀ in the world coordinate system Σ of the teaching point P2 designated in the task space, and hereinafter, will be also referred to as a “target position.”

The convergence determination unit 405 reads, from the convergence determination value storage unit 404, convergence determination values (allowable values indicating upper and lower limit values in an allowable range) of a target operation (step S2). The convergence determination unit 405 sets convergence widths (the allowable ranges) by distributing these values with the positions x₀, y₀, and z₀ in the respective x, y, z-axis directions that serve as the target positions of the leading edge of the robot 100 in the detection target operation, being used as center values.

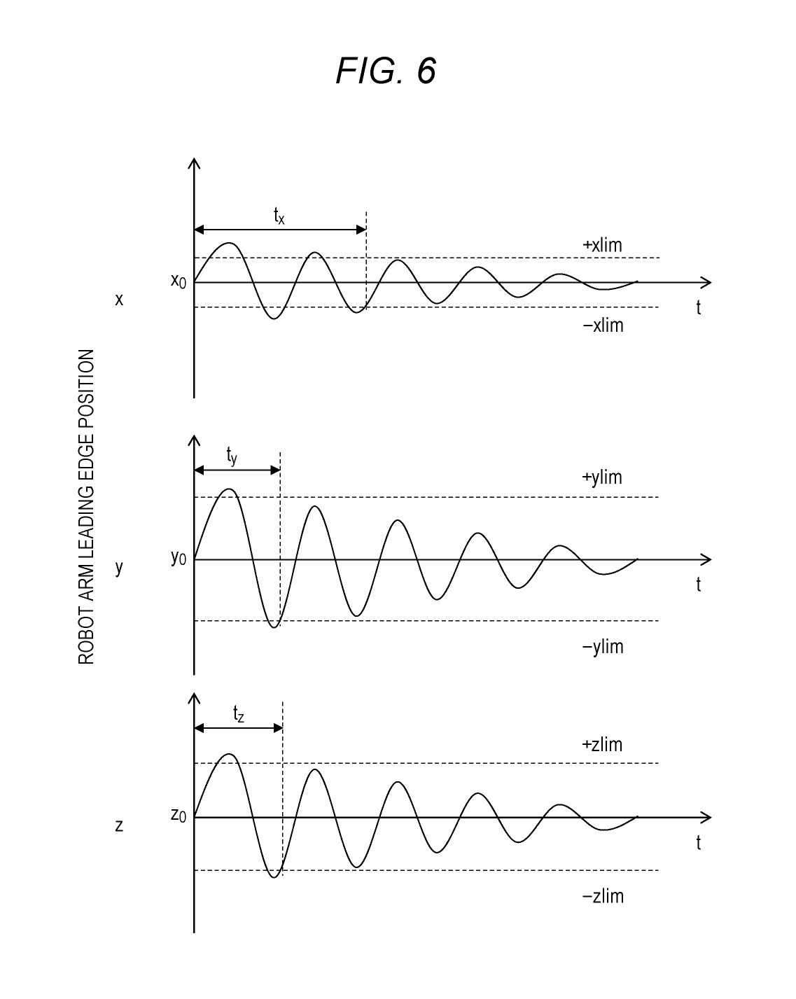

FIG. 6 illustrates graphs for describing vibration statuses of the leading edge of the robot 100 in the respective x, y, z-axis directions in the world coordinate system Σ. A convergence determination value is preset (stored in the HDD 204 serving as a storage unit) by the user for each of the x, y, z-axis directions according to required accuracy.

The graphs in the respective directions that are illustrated in FIG. 6 indicate positions of the leading edge of the robot 100 (i.e., the robot arm 101) in the respective x, y, z-axis directions, in this order from the top, in the world coordinate system. In these graphs, vertical axes indicate positions, and horizontal axes indicate elapsed times t. An origination 0 in each horizontal axis (time axis) corresponds to a time point at which a command from the servo control device 230 to the motor 1 is completed, that is, a time point at which the rotational angles θₘ₁ to θₘ₆ of the respective motors 1 are controlled to be the target angles θₘ₁* to θₘ₆*.

In the x-axis direction, a target position (operation completion position) is x₀, and a convergence width (an allowable range) −xlim to +xlim is set with the value x₀ being at the center. In short, the allowable range is [x₀−xlim, x₀+xlim]. A convergence time tₓ is a time taken for the leading edge position of the robot 100 to converge within the convergence width (allowable range), and for the vibration in the x-axis direction to be determined to have converged.

In the y-axis direction, a target position (operation completion position) is y₀, and a convergence width (an allowable range) −ylim to +ylim is set with the value y₀ being at the center. In short, the allowable range is [y₀−ylim, y₀+ylim]. A convergence time t_{y} is a time taken for the leading edge position of the robot 100 to converge within the convergence width (allowable range), and for the vibration in the y-axis direction to be determined to have converged.

In the z-axis direction, a target position (operation completion position) is z₀, and a convergence width (an allowable range) −zlim to +zlim is set with the value z₀ being at the center. In short, the allowable range is [z₀−zlim, z₀+zlim]. A convergence time t_{z} is a time taken for the leading edge position of the robot 100 to converge within the convergence width (allowable range), and for the vibration in the z-axis direction to be determined to have converged.

For example, in a case in which high accuracy is required only for the x-axis direction in the second operation following the first operation, a vibration amount in the x-axis direction at the completion of the first operation strongly affects the accuracy of the subsequent second operation. In this case, an absolute value of the convergence determination values +xlim and −xlim in the x-axis direction is set to a small value. In the remaining y and z-axis directions, the vibration amounts do not affect the accuracy of the subsequent second operation so much. Thus, absolute values of convergence determination values in these directions are set to large values so as to shift to the subsequent second operation as early as possible.

As described above, in the first exemplary embodiment, when a command of target positions x₀, y₀, and z₀ (specifically, target angles of the respective motors 1, or angles obtained by dividing the target angles by the speed reduction ratio N) is issued to the servo control device 230, convergence widths centered on the respective target positions x₀, y₀, and z₀ are set as illustrated in FIG. 6. The size of such a convergence width can be arbitrarily set by the user. The convergence width is only required to be set to a small value if the operating accuracy is required, and to be set to a large value if the operation speed is required.

As illustrated in FIG. 6, vibration in the y and z-axis directions is large, but convergence determination values can be set to large values if high accuracy of the subsequent second operation is not required. As a result, the convergence times t_{y} and t_{z} become shorter, and the robot 100 can shift to the subsequent second operation earlier. This enables an efficient operation of the robot 100. The convergence determination values may be set to values separately obtained through experiments. Alternatively, the convergence determination values may be arranged to be selectable by the user from among several levels of values prepared in advance. The convergence times tₓ, t_{y}, and t_{z} are obtained through estimation in step S6 to be described below.

Next, the convergence determination unit 405 causes the timer 206 to start time measurement at a time point at which the rotational angles (detected angles of the input side encoders 10) θₘ₁ to θₘ₆ of the respective motors 1 become the target angles θₘ₁* to θₘ₆*. In addition, at the time point at which the rotational angles θₘ₁ to θₘ₆ of the respective motors 1 become the target angles θₘ₁* to θₘ₆*, the convergence determination unit 405 pauses rotational operations (driving) of the respective motors 1 of the robot 100 so that the robot 100 does not shift to the subsequent second operation (step S3).

Next, the actual output angle calculation unit 402 obtains the joint angles θ_{J1} to θ_{J6} of the respective joints J1 to J6 based on pulse signals from the respective output side encoders 16. In other words, the actual output angle calculation unit 402 acquires the joint angles θ_{J1} to θ_{J6} of the respective joints J1 to J6 that are detected by the respective output side encoders 16 (step S4).

Next, the leading edge position calculation unit 403 obtains the position of the leading edge (TCP) of the robot 100 (the robot arm 101) based on the joint angles θ_{J1} to θ_{J6} detected by the respective output side encoders 16 (step S5: leading edge position calculation step). The above-described steps S4 and S5 start at the stage of completion of an operation command to the motor 1 in the first operation. At this time, operations of the respective motors 1 of the robot 100 are stopped, but an outer portion from the speed reducer 11, i.e., the leading edge of the robot 100 is in a vibrating state. The leading edge position of the robot 100 is obtained by calculating the joint angles θ_{J1} to θ_{J6} of the respective joints J1 to J6 according to the direct kinematics.

Next, the convergence determination unit 405 estimates a convergence time taken for the leading edge position of the robot 100 to converge within a convergence width (within an allowable range) (step S6: estimation step). Here, a time point “t” at which the rotational angles θₘ₁ to θₘ₆ of the respective motors 1 are controlled to be the target angles θₘ₁* to θₘ₆ is assumed to be t=0. A time point “t” at which an amplitude at the leading edge of the robot 100 with respect to an operation completion position converges within an allowable range is assumed to be t=tₓ, t_{y}, and t_{z}. Thus, convergence times are the convergence times tₓ, t_{y}, and t_{z}. In step S6, the convergence determination unit 405 executes estimation processing of estimating the convergence times tₓ, t_{y}, and t_{z} based on a time change of the leading edge position of the robot 100 that is calculated in step S5.

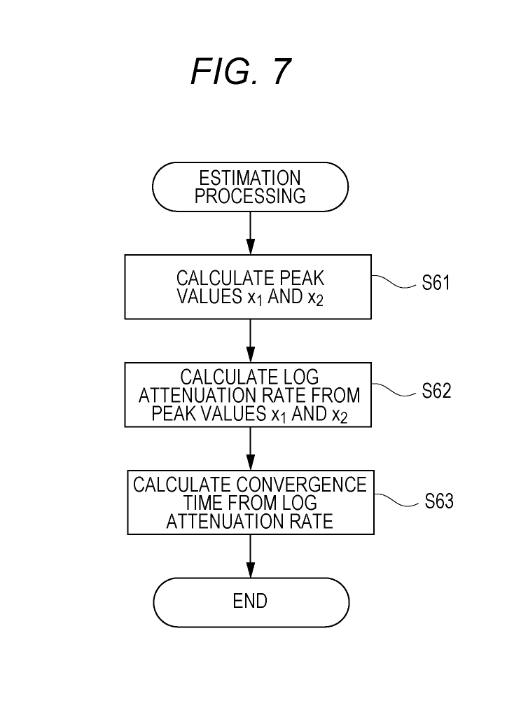

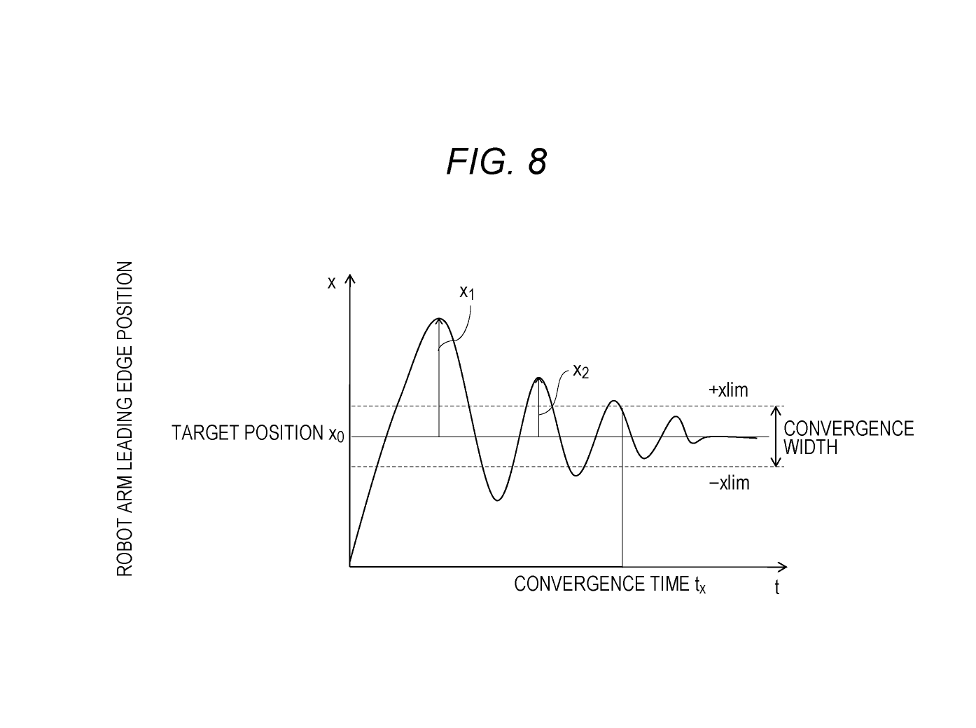

The estimation step in step S6 will now be specifically described. FIG. 7 is a flowchart illustrating an estimation step in the robot control method according to the first exemplary embodiment of the present invention. FIG. 8 is a conceptual diagram for describing the estimation step. In a graph illustrated in FIG. 8, a horizontal axis indicates a time “t,” and a vertical axis indicates a leading edge position “x” in one axis direction (the x-axis direction) among the three-axis directions of leading edge positions x, y, and z. In addition, since the same applies to the other axes (y and z-axes), the descriptions thereof will be omitted.

As illustrated in FIG. 8, the leading edge position of the robot 100 (the robot arm 101) gradually attenuates to converge on a target position x₀ while reciprocating within and outside a convergence width (an allowable range between two broken lines) centered on the target position x₀. Thus, in the first exemplary embodiment, the convergence determination unit 405 estimates a time tₓ at which the leading edge position of the robot 100 no longer departs from the convergence width due to the vibration of the robot 100.

More specifically, first, the CPU 201 calculates at least two peak values, i.e., two peak values x₁ and x₂ in the present exemplary embodiment, of the vibration of the leading edge of the robot 100 based on the time change of the leading edge position “x” of the robot 100 that is calculated in step S5 (step S61). More specifically, the CPU 201 acquires the joint angles θ_{J1} to θ_{J6} from the respective output side encoders 16 at a predetermined time interval to obtain the leading edge position. Thus, the CPU 201 identifies the peak values x₁ and x₂ at time points at which the leading edge position passes through the respective peak values x₁ and x₂ to come closer to the target position x₀. In other words, the CPU 201 obtains at least two peak values x₁ and x₂ identified earlier in chronological order.

Next, the CPU 201 estimates a convergence time tₓ based on the peak values x₁ and x₂. More specifically, the CPU 201 first calculates a log attenuation rate from the two peak values x₁ and x₂ after identifying the peak value x₂ (step S62). The log attenuation rate is represented by a logarithm natural of a rate of adjacent amplitudes. In a waveform of a robot arm leading edge position illustrated in FIG. 8, a log attenuation rate G is represented by the following formula:

$$σ = In \frac{{X}_{1}}{{X}_{2}}$$

Subsequently, the CPU 201 calculates the convergence time tₓ from the calculated log attenuation rate (step S63).

The convergence time tₓ is estimated through steps S61 to S63 described above. The convergence times t_{y} and t_{z} are similarly estimated. In addition, a case of obtaining a log attenuation rate has been described as an estimation method, but an estimation method is not limited to this method. The convergence time may be estimated by obtaining a function of an attenuating waveform from a plurality of pieces of sampling data of the leading edge position. Alternatively, the convergence time may be estimated by estimating a peak value following two peak values, and a timing thereof.

In this manner, in the first exemplary embodiment, the CPU 201 estimates the convergence times tₓ, t_{y}, and t_{z} in the respective x, y, and z-axis directions in the world coordinate system Σ.

Next, in FIG. 5, after the estimation of the convergence times tₓ, t_{y}, and t_{z} in step S6 is finished, the convergence determination unit 405 determines whether the convergence times tₓ, t_{y}, and t_{z} have elapsed (step S7). Specifically, the convergence determination unit 405 determines whether the longest convergence time (the convergence time tₓ in the first exemplary embodiment) among the convergence times tₓ, t_{y}, and t_{z} has elapsed.

If the time measured by the timer 206 is less than the convergence time tₓ (No in step S7), the convergence determination unit 405 continues to pause the motors 1 of the robot 100. If the convergence determination unit 405 determines that the time measured by the timer 206 reaches the convergence time tₓ (Yes in step S7), the convergence determination unit 405 causes the robot 100 to perform the subsequent second operation (step S8).

It is preferable to cause the robot 100 to perform the second operation at a timing at which positive determination is made in step S7, but this is not a limiting case. In other words, if the positive determination is made in step S7, the subsequent second operation becomes executable, and a timing at which the second operation is actually performed may be any timing so long as the timing is after the positive determination is made. It is preferable to start the second operation after the positive determination is made and before next vibration reaches its peak.

As described above, in steps S3 and S7, the CPU 201 pauses the rotational operations of the respective motors 1 at least from a time point at which the rotational angles of the respective motors 1 are controlled to be the target angles to a time point at which the measured time reaches the estimated convergence time tₓ, before causing the robot 100 to perform the second operation. In short, the CPU 201 executes a pause step in steps S3 and S7.

According to the first exemplary embodiment, the rotational operations of the respective motors 1 are paused at least for the convergence time estimated in step S6. Thus, a pause time can be shortened as compared to a case in which the rotational operations of the respective motors 1 are paused for a predetermined time. In addition, if the rotational operations of the respective motors 1 of the robot 100 are stopped at least for the convergence time, the vibration of the leading edge of the robot 100 converges within an allowable range. Thus, the operating accuracy of the robot 100 in the subsequent second operation can be ensured. In addition, since an extra stop time can be cut as compared to a case of stopping the robot 100 for a predetermined time, a series of operations (the first operation and the second operation) of the robot 100 can be performed in a shorter time, and the efficiency of an assembly work of an assembly part by the robot 100 can be enhanced.

In addition, in the first exemplary embodiment, at least two peak values of the vibration of the leading edge of the robot 100 are identified to estimate a convergence time. Thus, a subsequent peak value can be easily obtained based on attenuation characteristics, and the accuracy of an estimated convergence time is further enhanced. In particular, by calculating a log attenuation rate, a convergence time can be obtained based only on two peak values. Accordingly, the convergence time can be obtained more quickly.

In addition, the motors 1 of the robot 100 are stopped until the time count of the timer 206 reaches the convergence time tₓ that is the longest among the convergence times tₓ, t_{y}, and t_{z} of the three axes. Thus, the convergence times t_{y} and t_{z} have elapsed, and vibrations converge within the allowable ranges in all of the axis directions. This enhances the operating accuracy of the subsequent second operation of the robot 100.

Furthermore, according to the first exemplary embodiment, the leading edge position of the robot 100 can be obtained more accurately as compared to a case of calculating the leading edge position of the robot based on the rotational angles of the respective motors (input side of the speed reducer). Thus, a convergence time can be accurately estimated, and the work efficiency of the robot 100 is thereby enhanced.

In addition, since the allowable ranges can be individually set in the respective axis directions in the world coordinate system Σ, convergence determination values (allowable ranges) in directions in which the operating accuracy is not required can be set to large values, so that convergence times can be shortened, and the work efficiency of the robot 100 can be enhanced.

In addition, in the first exemplary embodiment, the description has been given of a case in which the convergence times are estimated in all the three axes, but this is not a limiting case. For example, if an axis direction in which a convergence time is the longest is known in advance due to the characteristics of the robot 100, only the convergence time in the direction may be estimated. In this case, it is sufficient that a stop time of the robot 100 is set only using the estimated convergence time.

### Second Exemplary Embodiment

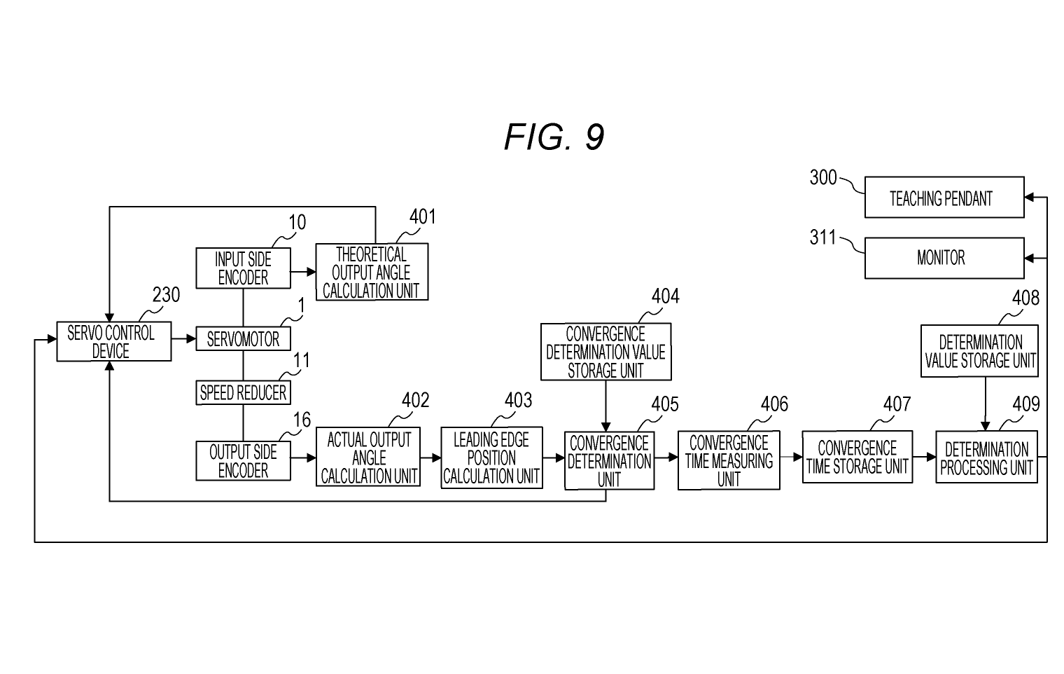

Next, the description will be given of a robot control method in a robot apparatus according to a second exemplary embodiment of the present invention. FIG. 9 is a functional block diagram illustrating a control system of a robot apparatus according to the second exemplary embodiment of the present invention. In addition, since the entire configuration of the robot apparatus is similar to the robot apparatus according to the first exemplary embodiment, the description thereof will be omitted. In the second exemplary embodiment, a control operation by the CPU 201 of the control device 200, i.e., the program 240 is different from that in the above first exemplary embodiment. In the second exemplary embodiment, points different from the above first exemplary embodiment will be mainly described below.

If the robot 100 (the robot arm 101) is used for a long time, the components constituting the robot 100 (the robot arm 101), such as the speed reducer 11, a timing belt (not illustrated), and the like, show the influence of a chronological change. As the robot 100 deteriorates with age, a convergence time of the vibration of the leading edge of the robot 100 (the robot arm 101) changes to be longer.

In view of the foregoing, in the second exemplary embodiment, the description will be given of a method for detecting the age deterioration of the robot 100 (the robot arm 101) without disassembling the robot 100, based on a chronological change in an actually measured convergence time.

The components illustrated in FIG. 9 will be described below. In the second exemplary embodiment, in addition to the calculation units 401, 402, 403, and 405 in FIG. 4 that have been described in the above first exemplary embodiment, the CPU 201 also functions as calculation units 406 and 409. Furthermore, in addition to the storage unit 404 in FIG. 4 that has been described in the above first exemplary embodiment, the HDD 204 also functions as storage units 407 and 408. In addition, in the second exemplary embodiment, the descriptions of the units 401 to 405 common to the above first exemplary embodiment will be omitted. The calculation units 401, 402, 403, 405, 406, and 409 illustrated in FIG. 9 function by the CPU 201 executing the program 240.

The convergence time measuring unit 406 measures an actual convergence time from a time point at which an operation command from the servo control device 230 is completed to a time point at which the convergence determination unit 405 determines convergence. The convergence time storage unit 407 stores the convergence time obtained by the convergence time measuring unit 406, as data of a chronological change T_{f}. Here, the chronological change T_{f} refers to a time change amount (or a value proportional to the time change amount) of a convergence time at the present moment with respect to a convergence time at an initial operation. The convergence time at an initial operation is preferably set to a convergence time obtainable when the robot 100 is first operated. Alternatively, the convergence time at an initial operation may be set to a convergence time specified by the user (e.g., a convergence time obtainable when the robot 100 is operated a number of times specified by the user.

The determination value storage unit 408 stores a determination value (an allowable value) for the chronological change T_{f} of the actually measured convergence time. In the second exemplary embodiment, several levels of determination values (allowable values) may be prepared. Specifically, the determination value storage unit 408 stores (sets) a notification determination value T₁ used at a level where the user is to be notified only of warning, and a stop determination value T₂ used at a level where the robot 100 needs to be stopped in addition to warning. In this case, the determination value T₁<the determination value T₂. The determination values T₁ and T₂ may be set by experimentally obtaining in advance the relationship between a convergence time and the deterioration of the robot 100. Alternatively, the determination values T₁ and T₂ may be set according to the degree of influence of a convergence time that is exerted on a takt time of the manufacturing including operations of the robot 100.

The determination processing unit 409 compares the chronological change T_{f} of the convergence time that is stored in the convergence time storage unit 407, with the determination values T₁ and T₂ that are stored in the determination value storage unit 408, and issues a warning command and/or a stop command of the robot 100. This processing will be described below.

As a processing method of the chronological change T_{f} of the convergence time, for example, a moving averaging method can be desirably used. It is desirable to cause a notification means that can be easily checked by the user, such as the teaching pendant 300 and the monitor 311, for example, to display (issue the notification of) a warning command. A stop command of the robot 100 (the robot arm 101) is transmitted to the servo control device 230.

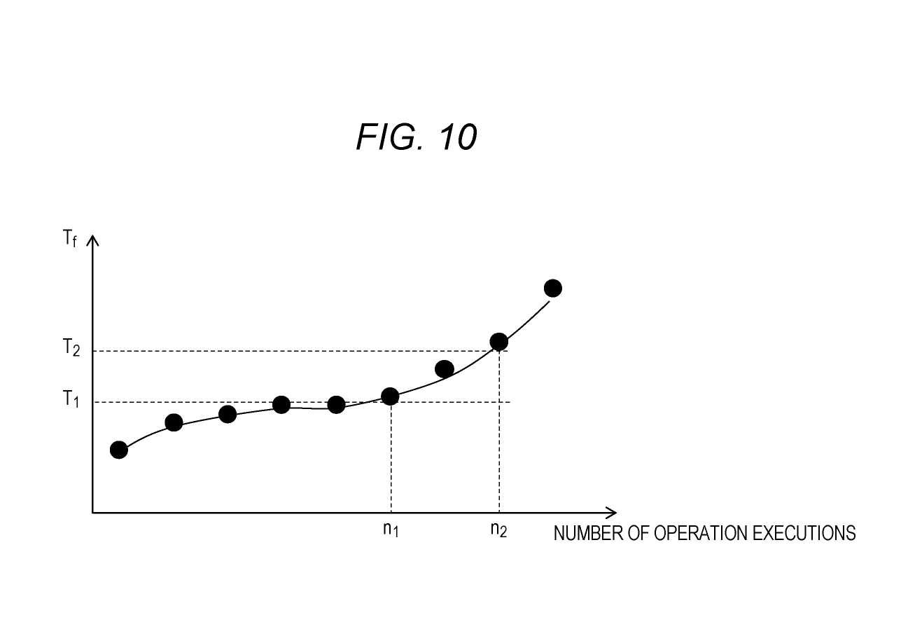

FIG. 10 is a diagram for describing data processing of a chronological change T_{f} in the determination processing unit 409. In FIG. 10, a vertical axis indicates a chronological change T_{f} of a convergence time, and a horizontal axis indicates the number of executions of a target operation. In the example illustrated in FIG. 10, two types of determination values are set. One is the notification determination value T₁ for issuing, to the user, the warning notification about the chronological change T_{f} of the convergence time. The other one is the stop determination value T₂ for stopping the robot 100 (the robot arm 101) in addition to issuing the warning to the user. If it is determined that the chronological change T_{f} of the convergence time exceeds the determination value T₁ at an n₁th execution of the target operation, the warning is issued to the user. In addition, if it is determined that the chronological change T_{f} of the convergence time exceeds the determination value T₂ at an n₂th execution, the robot 100 is stopped in addition to the issuance of the warning to the user.

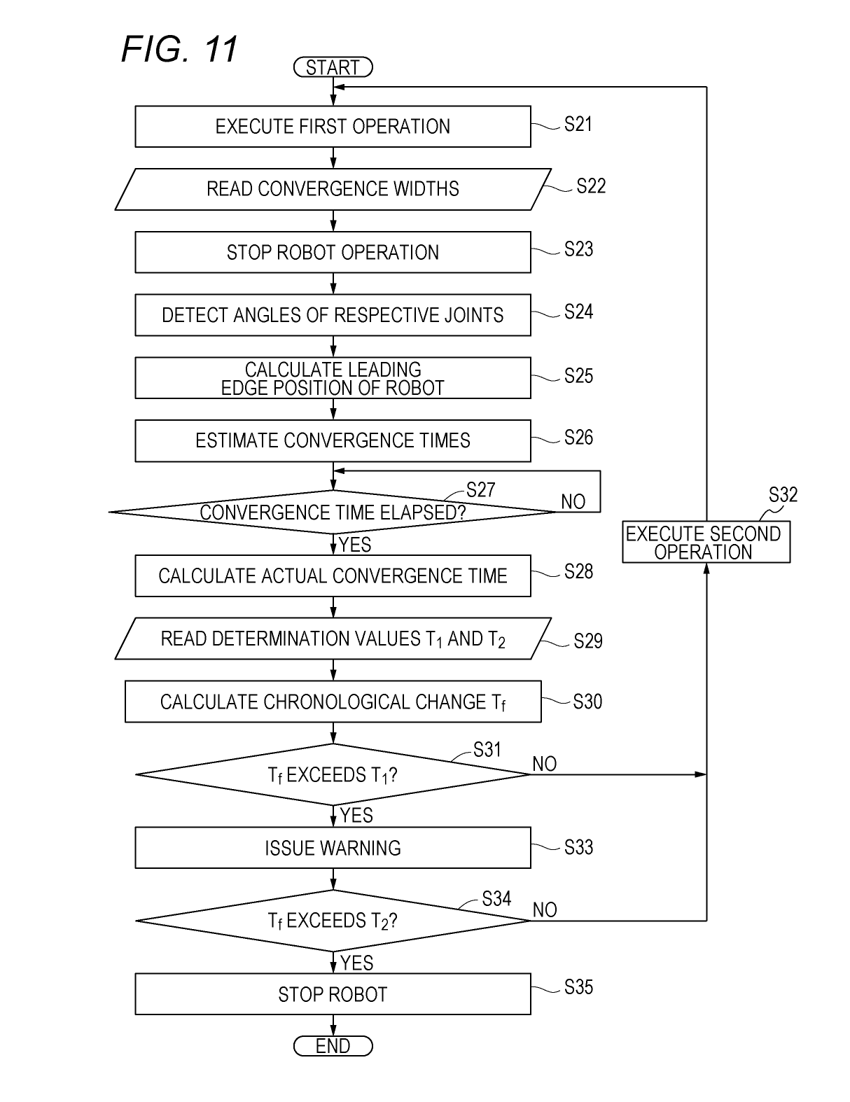

FIG. 11 is a flowchart illustrating each step of a robot control method in the robot apparatus according to the second exemplary embodiment of the present invention. A processing flow in the second exemplary embodiment will be described below. Here, steps S21 to S27 are similar to steps S1 to S7 described in the first exemplary embodiment, so the descriptions thereof will be omitted.

The convergence time measuring unit 406 calculates (measures) a time (an actual convergence time) taken for the vibration of the leading edge of the robot 100 that is calculated in step S25 to actually converge within an allowable range (step S28). This actual convergence time is a time from a time point at which an operation command from the servo control device 230 is completed to a time point at which the convergence determination unit 405 performs the convergence determination to determine that the vibration of the robot 100 has actually converged within the allowable range.

The determination processing unit 409 reads the determination values T₁ and T₂ prestored in the determination value storage unit 408 (step S29).

Next, the determination processing unit 409 obtains a chronological change T_{f} by processing the actually measured convergence time (step S30). More specifically, the convergence time measuring unit 406 stores the measured convergence time into the convergence time storage unit 407. The determination processing unit 409 obtains a chronological change T_{f} of the convergence time read from the convergence time storage unit 407, using a moving averaging method or the like.

The determination processing unit 409 determines whether the chronological change T_{f} exceeds the notification determination value T₁ (step S31: notification determination step).

If the determination processing unit 409 determines that the chronological change T_{f} does not exceed the notification determination value T₁ (No in step S31), the robot 100 is caused to execute the second operation similarly to step S8 described in the above first exemplary embodiment (step S32).

If the determination processing unit 409 determines that the chronological change T_{f} exceeds the notification determination value T₁ (Yes in step S31), the monitor 311 or the teaching pendant 300 serving as a notification means is caused to perform the notification (display) of the warning (step S33: notification step).

Next, the determination processing unit 409 determines whether the chronological change T_{f} exceeds the stop determination value T₂ (step S34: stop determination step).

If the determination processing unit 409 determines that the chronological change T_{f} does not exceed the stop determination value T₂ (No in step S34), the robot 100 is caused to execute the second operation similarly to step S8 described in the above first exemplary embodiment (step S32).

If the determination processing unit 409 determines that the chronological change T_{f} exceeds the stop determination value T₂ (Yes in step S34), the emergency stop of an operation of the robot 100 is performed (step S35: emergency stop step).

As described above, according to the second exemplary embodiment, by determining the data of the chronological change T_{f} of the convergence time based on the determination value T₁, the user can determine a deteriorated state of the robot 100 without disassembling the robot 100. In addition, by determining the data of the chronological change T_{f} of the convergence time based on the determination value T₂, and by stopping the deteriorated robot 100, an assembling work using the robot 100 in the deteriorated state can be avoided. As described above, according to the second exemplary embodiment, since the deteriorated state of the robot 100 is determined based on the two levels of values, i.e., the determination values T₁ and T₂, the maintenance performance is enhanced.

In addition, in the second exemplary embodiment, the description has been given of a case in which the determination is performed based on the determination values T₁ and T₂, but this is not a limiting case. The determination may be performed only based on the determination value T₁ or only based on the determination value T₂. In other words, steps S31 and S33, or steps S34 and S35 may be omitted. If steps S31 and S33 are omitted, in step S35, in addition to the stopping operation of the robot 100, the notification of the warning may be issued similarly to step S33.

In addition, in the second exemplary embodiment, the description has been given of a case in which an actually measured convergence time is used as a convergence time of which a chronological change T_{f} is obtained. Alternatively, a convergence time estimated in step S26 may be used. In this case, the actual measurement of a convergence time can be omitted.

As described above, the exemplary embodiments of the present invention have been described. However, the present invention is not limited to the above-described exemplary embodiments. In addition, the effects described in the exemplary embodiments of the present invention are merely given as the most preferable effects achieved by the present invention. Thus, the effects achieved by the present invention are not limited to those described in the exemplary embodiments of the present invention.

### Other Exemplary Embodiments

The present invention can be also realized by processing of supplying a program for implementing one or more functions of the above exemplary embodiments, to a system or an apparatus via a network or a storage medium, and reading and executing the program by one or more processors in a computer of the system or the apparatus. In addition, the present invention can be also realized by a circuit (e.g., an application specific integrated circuit (ASIC)) for implementing one or more functions.

In addition, in the above exemplary embodiments, the description has been given of a case in which the multijoint robot 100 is a vertical multijoint robot. Alternatively, the multijoint robot 100 may be a horizontal multijoint robot (selective compliance assembly robot arm (SCARA) robot), a parallel link robot, or the like.

According to the present invention, a leading edge position of a robot is obtained based on joint angles actually measured by respective joint angle detectors, a convergence time of the vibration of the leading edge of the robot is estimated based on a time change thereof, and the robot is paused at least for the convergence time. As a result, the robot can be operated in a short time while ensuring the operating accuracy of the robot, so that the work efficiency of the robot is enhanced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-217032, filed Oct. 24, 2014, which is hereby incorporated by reference herein in its entirety.

What is claimed is:

1. A robot control method for a multijoint robot including motors for driving respective joints, and joint angle detectors for detecting angles of the respective joints, and for causing the robot to perform a second operation after causing the robot to perform a first operation, by controlling rotations of the respective motors by a control means, the robot control method comprising:
a robot operation step of controlling, by the control means, rotations of the respective motors so that rotational angles of the respective motors become target angles in an operation completion position of the first operation;
a leading edge position calculation step of obtaining, by the control means, a position of a leading edge of the robot based on joint angles detected by the respective joint angle detectors, after the robot operation step;
an estimation step of estimating, by the control means, a convergence time from when the rotational angles of the respective motors are controlled to be the target angles in the robot operation step to when an amplitude at the leading edge of the robot with respect to the operation completion position converges within an allowable range, based on a time change of the position of the leading edge of the robot that is calculated in the leading edge position calculation step; and
a pause step of pausing, by the control means, rotational operations of the respective motors at least from a time point at which the rotational angles of the respective motors are controlled to be the target angles in the robot operation step to a time point at which an elapsed time reaches the convergence time estimated in the estimation step, before causing the robot to perform the second operation.

2. The robot control method according to claim 1, wherein in the estimation step, the control means obtains peak values of vibration of the leading edge of the robot based on a time change of the position of the leading edge of the robot that is calculated in the leading edge position calculation step, and estimates the convergence time based on at least two peak values.

3. The robot control method according to claim 2, wherein in the estimation step, the control means obtains a log attenuation rate of the at least two peak values, and obtains the convergence time from the log attenuation rate.

4. The robot control method according to claim 1,
wherein in the estimation step, the control means estimates the convergence times in respective axis directions in a world coordinate system, and
wherein in the pause step, the control means pauses rotational operations of the respective motors at least from a time point at which the rotational angles of the respective motors are controlled to be the target angles in the robot operation step to a time point at which an elapsed time reaches a longest convergence time among the convergence times.

5. The robot control method according to claim 1, further comprising:
a notification determination step of determining, by the control means, whether a chronological change of the convergence time estimated in the estimation step or an actually measured actual convergence time exceeds a preset notification determination value; and
a notification step of issuing, by the control means, notification of a warning in a case in which the control means determines that the chronological change exceeds the notification determination value.

6. The robot control method according to claim 5, further comprising:
a stop determination step of determining, by the control means, whether a chronological change of the convergence time estimated in the estimation step or an actually measured actual convergence time exceeds a preset stop determination value; and
an emergency stop step of stopping, by the control means, an operation of the robot in a case in which the control means determines that the chronological change exceeds the stop determination value.

7. A computer-readable recording medium storing instructions that, when executed by a computer, cause the computer to perform the method according to claim 1.

8. A manufacturing method of an assembly part for manufacturing an assembly part by executing each step of the robot control method according to claim 1, causing the robot to grip a first part to perform the first operation, and after pausing the robot for the convergence time, assembling the first part to a second part in the second operation.

9. A robot apparatus comprising:
a multijoint robot including motors for driving respective joints, and joint angle detectors for detecting angles of the respective joints; and
a control means configured to control rotations of the respective motors of the robot, and to execute each step of the robot control method according to claim 1.
